(19) United States
(12) Patent Application Publication
(10) Pub. No.: US 2025/0157083 A1
(43) Pub. Date: May 15, 2025

(54) EFFICIENT CODING OF ATTRIBUTES IN POLYGON MESH COMPRESSION

(71) Applicant: Tencent America LLC, Palo Alto, CA (US)

(72) Inventors: Chao HUANG, Palo Alto, CA (US); Thuong NGUYEN CANH, Palo Alto, CA (US); Xiaozhong XU, State College, PA (US); Shan LIU, San Jose, CA (US)

(73) Assignee: Tencent America LLC, Palo Alto, CA (US)

(21) Appl. No.: 18/923,657

(22) Filed: Oct. 22, 2024

Related U.S. Application Data
(60) Provisional application No. 63/547,961, filed on Nov. 9, 2023.
(60) Provisional application No. 63/547,963, filed on Nov. 9, 2023.

(51) Int. Cl. G06T 9/00

(52) U.S. Cl. CPC G06T 9/001

(57) ABSTRACT

A bitstream that includes attribute information of a plurality of UV vertices corresponding to a mesh is received. A seam vertex queue that includes one or more UV vertices of the plurality of UV vertices is generated. Each of the one or more UV vertices in the seam vertex queue belongs to a respective UV vertex group of a plurality of seam UV vertex groups. Each of the plurality of seam UV vertex groups corresponds to a same three-dimensional (3D) vertex of the mesh in a 3D space. An initial UV vertex of the mesh is determined based on whether one of the one or more UV vertices in the seam vertex queue includes an unvisited UV vertex. UV coordinates of the mesh are reconstructed based on the initial UV vertex.

### INCORPORATION BY REFERENCE

The present application claims the benefit of priority to U.S. Provisional Application No. 63/547,961, “Efficient Coding of Normals in Polygon Mesh Compression” filed on Nov. 9, 2023, and U.S. Provisional Application No. 63/547,963, “Efficient Coding of Texture Coordinates for Polygon Mesh Compression” filed on Nov. 9, 2023. The entire disclosures of the prior applications are hereby incorporated by reference in their entirety.

### TECHNICAL FIELD

The present disclosure describes aspects generally related to mesh coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

Advances in three-dimensional (3D) capture, modeling, and rendering have promoted 3D content across various platforms and devices. For example, a baby's first step in one continent is captured and grandparents may see (and in some cases interact) and enjoy a full immersive experience with the child in another continent. In order to achieve such realism, models are becoming more sophisticated, and a significant amount of data is linked to the creation and consumption of those models. 3D meshes are widely used to represent such immersive contents.

### SUMMARY

Aspects of the disclosure include bitstreams, methods, and apparatuses for mesh processing. In some examples, an apparatus for mesh processing includes processing circuitry.

According to an aspect of the disclosure, a method of mesh decoding is provided. In the method, a bitstream that includes attribute information of a plurality of UV vertices corresponding to a mesh is received. A seam vertex queue that includes one or more UV vertices of the plurality of UV vertices is generated. Each of the one or more UV vertices in the seam vertex queue belongs to a respective UV vertex group of a plurality of seam UV vertex groups. Each of the plurality of seam UV vertex groups corresponds to a same three-dimensional (3D) vertex of the mesh in a 3D space. An initial UV vertex of the mesh is determined based on whether one of the one or more UV vertices in the seam vertex queue includes an unvisited UV vertex. UV coordinates of the mesh are reconstructed based on the initial UV vertex.

According to another aspect of the disclosure, a method of mesh encoding is provided. In the method, a seam vertex queue that includes one or more UV vertices of a plurality of UV vertices of a mesh is generated. Each of the one or more UV vertices in the seam vertex queue belongs to a respective UV vertex group of a plurality of seam UV vertex groups. Each of the plurality of seam UV vertex groups corresponds to a same three-dimensional (3D) vertex of the mesh in a 3D space. An initial UV vertex of the mesh is determined based on whether one of the one or more UV vertices in the seam vertex queue includes an unvisited UV vertex. UV coordinates of the mesh are encoded based on the initial UV vertex.

According to yet another aspect of the disclosure, a method of processing mesh data is provided. In the method, a bitstream of the mesh data is processed according to a format rule. The bitstream includes attribute information of a plurality of UV vertices corresponding to a mesh. The format rule specifies that a seam vertex queue that includes one or more UV vertices of the plurality of UV vertices is generated. Each of the one or more UV vertices in the seam vertex queue belongs to a respective UV vertex group of a plurality of seam UV vertex groups. Each of the plurality of seam UV vertex groups corresponds to a same three-dimensional (3D) vertex of the mesh in a 3D space. The format rule specifies that an initial UV vertex of the mesh is determined based on whether one of the one or more UV vertices in the seam vertex queue includes an unvisited UV vertex. The format rule specifies that UV coordinates of the mesh are processed based on the initial UV vertex.

Aspects of the disclosure also provide an apparatus for mesh encoding. The apparatus for mesh encoding including processing circuitry configured to implement any of the described methods for mesh encoding.

Aspects of the disclosure also provide an apparatus for mesh decoding. The apparatus for mesh decoding including processing circuitry configured to implement any of the described methods for mesh decoding.

Aspects of the disclosure also provide a non-transitory computer-readable medium storing instructions which, when executed by a computer, cause the computer to perform any of the described methods for mesh decoding, encoding, and mesh data processing.

Technical solutions of the disclosure include methods and apparatuses for improving coding efficiencies of attributes of a mesh in polygon mesh compression. In some aspects, coding efficiencies of UV coordinates and normals of the mesh are improved. In an example, a bitstream that includes attribute information of a plurality of UV vertices corresponding to a mesh is received. A seam vertex queue that includes one or more UV vertices of the plurality of UV vertices is generated. Each of the one or more UV vertices in the seam vertex queue belongs to a respective UV vertex group of a plurality of seam UV vertex groups. Each of the plurality of seam UV vertex groups corresponds to a same three-dimensional (3D) vertex of the mesh in a 3D space. An initial UV vertex of the mesh is determined based on whether one of the one or more UV vertices in the seam vertex queue includes an unvisited UV vertex. UV coordinates of the mesh are reconstructed based on the initial UV vertex. Thus, the current disclosure allows the UV coordinates to be predictively coded from one face to another face of a mesh even when the faces of the mesh are disconnected. In related examples, when all faces of a mesh are disconnected, each face of the mesh may only be coded individually.

In an example, a first component n₁ of a first normal n of the mesh and a second component n₂ of the first normal n are reconstructed based on the attribute information of the mesh in the bitstream. A third component n₃ of the first normal n is reconstructed as a square root of (1−n₁²−n₂²) when the third component n₃ is equal to or larger than zero. The third component n₃ of the first normal n is reconstructed as a negative square root of (1-n₁²−n₂²) when the third component n₃ is less than zero. Thus, instead of using prediction information for the third component n₃ of the first normal n, the fact that normals vectors only have two degrees of freedom can be used to predict the third component n₃ based on the first component n₁ and the second component n₂. The resulting calculation not only reduces the bits required to signal the prediction information for the third component n₃ but usually results in a prediction error that is smaller when compared to directly using the prediction information of the third component n₃.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of texture/UV coordinates according to an aspect of the disclosure.

FIG. 5 shows an example of normal vectors of a polygon mesh according to an aspect of the disclosure.

FIG. 6 shows a flow chart outlining a mesh decoding process according to some aspects of the disclosure.

FIG. 7 shows a flow chart outlining a mesh encoding process according to some aspects of the disclosure.

FIG. 8 is a schematic illustration of a computer system in accordance with an aspect of the disclosure.

### DETAILED DESCRIPTION

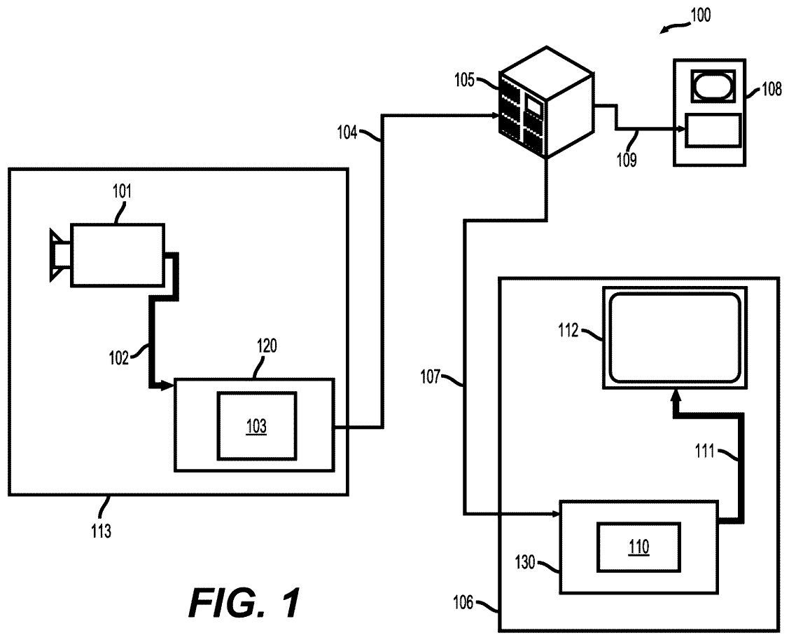

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101). The video source (101) may include one or more images captured by a camera and/or generated by a computer. For example, a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

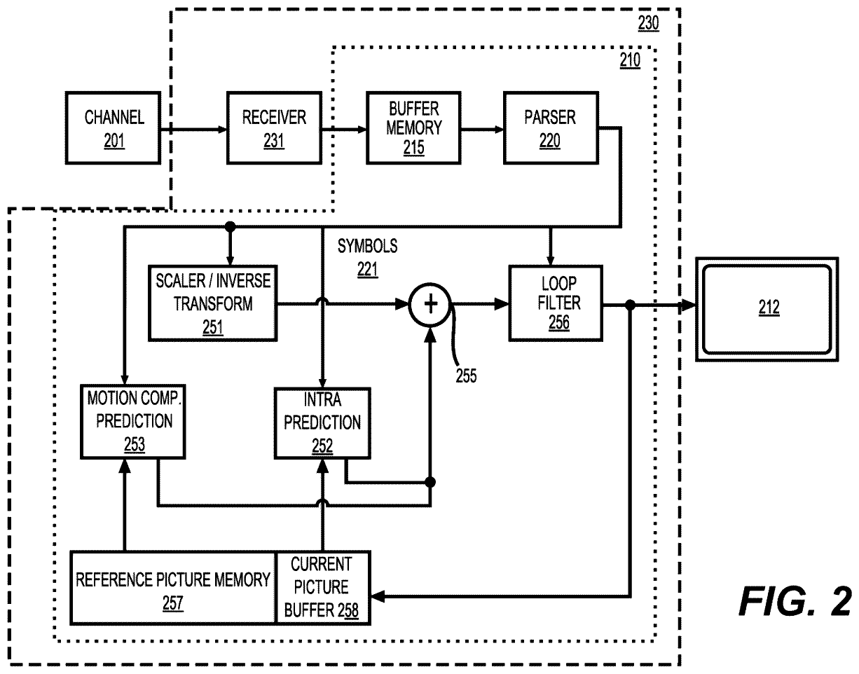

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

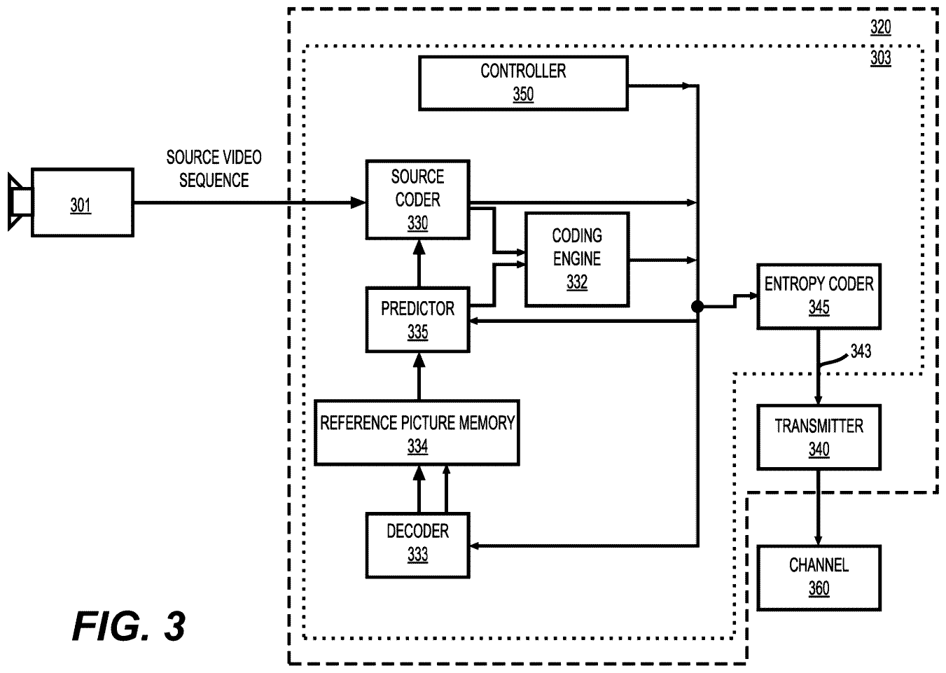

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture (or a mesh) to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks, such as a polygon-shaped or triangular block. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure includes methods and systems directed to efficient coding attributes in polygon mesh compression. In an aspect, UV coordinate values are coded when all faces in a UV space are disconnected. In an aspect, normal vectors are efficiently coded for polygon mesh compression.

A mesh may include several polygons that describe a surface of a volumetric object. Each polygon may be defined by vertices of the mesh in a 3D space and information of how the vertices are connected, referred to as connectivity information. Vertex attributes, such as colors, normals, displacements, etc., may be associated with the mesh vertices. Attributes may also be associated with a surface of the mesh by exploiting mapping information that parameterizes the mesh with two-dimensional (2D) attribute maps. Such mapping may be described by a set of parametric coordinates, referred to as UV coordinates or texture coordinates, associated with the mesh vertices. 2D attribute maps may be used to store high resolution attribute information such as texture, normals, displacements, etc. Such information may be used for various purposes, such as texture mapping, shading and mesh reconstruction, etc.

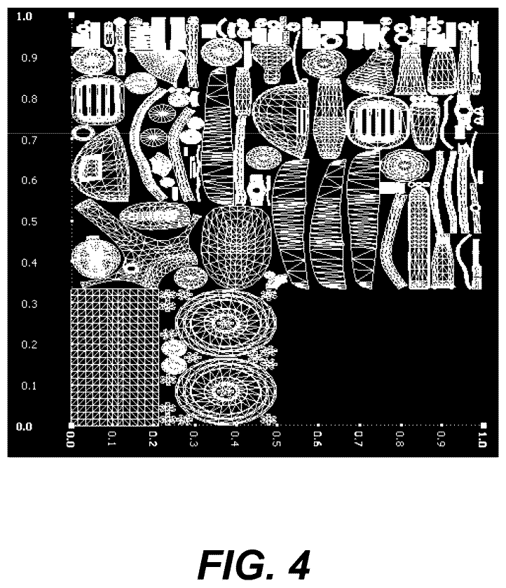

When a polygon mesh contains UV coordinates, such as UV coordinates shown in FIG. 4, values of the UV coordinates and the corresponding connectivity may be coded by a mesh codec, in which a value bitstream may be larger than a connectivity bitstream. To code the values of the UV coordinates, prediction schemes may be employed. For example, a value of each UV coordinate is predicted by either using a fixed value (e.g., zeros or centroids), a value of a previous UV coordinate, an average of last n UV coordinates, or parallelogram predictions, which includes across-parallelogram predictions and within-parallelogram predictions. Then, prediction residuals are encoded based on an encoding method, such as using an entropy coding.

In polygon mesh compression, a UV value bitstream may be a larger portion of a total UV bitstream compared to a connectivity bitstream, so methods are needed to code the UV coordinate values efficiently.

When a total number of vertices in a UV space is equal to a total face degree, all faces in the UV space may be disconnected. In an example, the total face degree is equal to a sum of total number of vertices incident to each face. In an example, a total face degree in a mesh refers to a sum of degrees of all faces within the mesh. A face degree is a measure of how many edges are incident to a particular face. In other words, the face degree is a total number of edges that form a boundary of that face. When all the faces in the UV space are disconnected, across-parallelogram prediction schemes may not be suitable to predict UV coordinates. However, a fact that certain UV vertices have the same UV coordinates may be applied to efficiently code the UVs (or UV coordinates).

In an aspect, in the context of mesh geometry, “incident to” refers to elements sharing a common boundary. For example, a face incident to an edge indicates that the edge is part of a boundary of the face. An edge incident to a vertex indicates that the vertex is one of endpoints of the edge. A vertex incident to a face indicates that the vertex is one of vertices defining the face.

In an example, if a group of UV vertices corresponds to a same 3D vertex, the group is called a seam UV vertex group (or group). All the UV vertices or some of the UV vertices in the group may have the same UV coordinates, although these UV vertices are distinct UV vertices. Based on such a fact, UV coordinates may be efficiently encoded according to subsequent procedures when all the faces in the UV space are disconnected.

In an aspect, UV vertices in a same seam UV vertex group may be organized in an order, such as a clockwise order or a counterclockwise order.

In an aspect, an initial vertex and a reference vertex of the initial vertex are determined. When a UV vertex is to be coded, whether the UV vertex (or to-be-coded UV vertex) belongs to a seam UV vertex group may be checked. To check whether the UV vertex belongs to a seam UV vertex group, whether the UV vertex and other UV vertices correspond to a same 3D vertex is checked. If the UV vertex and other UV vertices correspond to the same 3D vertex, the UV vertex is included in the seam UV vertex group as the other UV vertices. The UV vertex is then pushed into a queue, such as a seam vertex queue (e.g., seamVertQueue). It should be noted that vertices in the seam vertex queue may belong to different seam UV vertex groups. The vertices in the seam vertex queue may indicate disconnected positions of the mesh.

In an aspect, an initial vertex may further be identified, such as in the seamVertQueue. Remaining UV vertices and faces of the mesh may be encoded based on the initial vertex.

To identify the initial vertex, in a first example, if a top vertex (or a first vertex) in seamVertQueue has another unvisited UV vertex (or other unvisited UV vertices) in a same seam UV vertex group, then a first unvisited UV vertex (e.g., starting from the top vertex) is chosen as the initial vertex. The one or more unvisited (or uncoded) UV vertices and the initial vertex are in the same seam UV vertex group and correspond to a same 3D vertex of the mesh. A visited (or coded) vertex immediately preceding the initial vertex in the same seam UV vertex group may be chosen as a reference vertex.

In a second example, if the top vertex in the seamVertQueue has no unvisited UV vertex in the same seam UV vertex group, the top vertex may be popped (or removed) and a next top vertex in the seamVertQueue may be checked. If the next top vertex in the seamVertQueue has one or more unvisited UV vertices that are in a same seam UV vertex group as the next top vertex, an unvisited UV vertex (e.g., a first unvisited UV vertex with respect to the next top vertex) in the same seam UV vertex group of the next top vertex may be selected as the initial vertex. It should be noted that the top vertex and the next top vertex may be included in different seam UV vertex groups.

In a third example, if the seamVertQueue is empty (e.g., all vertices in the seam UV vertex group have been visited) and the initial vertex is not able to be identified, unvisited UV vertices may be checked from another seam vertex queue, such as a seam vertex queue that is not connected to already visited connected component (or the already visited seam vertex queue). If so, one of the unvisited UV vertices (e.g., a first one) in the other seam vertex queue may be chosen as the initial vertex. If no unvisited UV vertices are identified in the other seam vertex queue, all UV vertices of the mesh may have been coded. In an example, a reference vertex is chosen as a previously coded UV vertex as the initial vertex. The previously coded UV vertex may be included in the same seam UV vertex group as the initial vertex or in the seam vertex queue as the initial vertex. In an example, the reference vertex that is a fixed point in the UV space (e.g., an origin or center) may be applied as the reference vertex.

In an aspect, to encode a coordinate of the initial vertex, a coordinate of the reference vertex is applied to predict the coordinate of the initial vertex, then prediction residuals may further be encoded via an encoding method, such as via an entropy coding, a direct coding, a delta coding, an arithmetic coding, or the like.

In an aspect, an initial face is identified. The initial face is incident to the initial vertex. Rest vertices in the initial face are then coded based on the initial vertex.

In an example, to encode a coordinate of a second vertex in the initial face, if the initial vertex is determined in the third example, the coordinate of the initial vertex is applied to predict the coordinate of the second vertex, and prediction residuals are coded accordingly.

In an example, if the initial vertex is determined in the second example, a face that is incident to (or connect to) the reference vertex is firstly determined. The face may be named as a reference face. A coordinate of a vertex preceding the reference vertex in the reference face may be applied to predict the coordinate of the second vertex in the initial face.

In an example, a coordinate of a third vertex in the initial face may be coded by a stretch prediction. Coordinates of remaining vertices in the initial face, if any, may be coded by within-parallelogram predictions.

The stretch prediction in a mesh may involve estimating deformation or displacement of elements (e.g., vertices, edges, or faces) within the mesh under various loading conditions. An stretch prediction process may include: (1) mesh creation (e.g., define the initial geometry and topology of the mesh); (2) material assignment (e.g., assign appropriate material properties to each element); (3) loading definition (e.g., specify the forces, displacements, or pressure to be applied); (4) equation formulation (e.g., create a system of equations based on the chosen method and material properties); (5) equation solution (e.g., solve the system of equations to determine the displacements of the nodes or elements); and (5) visualization (e.g.,) display the deformed mesh to visualize the stretch prediction results).

In the within-parallelogram prediction, a position of a vertex may be predicted based on vertices within a same polygon. Since polygons tend to be fairly planar and convex, the within-parallelogram prediction generally results in more accurate predictions. According to the within-parallelogram prediction, a position of a vertex may be predicted based on vertices in a same polygon according to a parallelogram rule.

In an aspect, vertices that are in the same seam UV vertex group (or group) as the initial vertex are encoded when all the vertices in the initial face have been encoded. After coding all the vertices in the initial face, the UV vertices that are in the same seam UV vertex group as the initial vertex may be iterated, and a vertex subsequent to the initial vertex in the same seam UV vertex group as the initial vertex may be a starting point in the iteration.

In an example, if a UV vertex (or a first UV vertex subsequent to the initial vertex) in the group has already been visited, the vertex is skipped. Otherwise, if the UV vertex in the group is not visited, the UV vertex is treated as a current seam vertex (or current seam UV vertex). In an example, a seam UV vertex is a vertex in a 3D mesh that represents a discontinuity in the UV map. When a mesh is unwrapped into a 2D texture space (e.g., the UV space), seams are created to prevent excessive stretching or distortion of the UV map. These seams represent boundaries where the UV map is divided into separate sections or “islands.”

In an example, a coordinate of an unvisited vertex in the seam UV vertex group, which is called the current seam vertex, is predicted by a coordinate of a preceding vertex in the group.

In an example, a face incident to the current seam vertex is identified and called a current face. A second vertex incident to the current face may be coded as follows: (i) if the current seam vertex has a same UV coordinate as a preceding vertex in the group, or if a distance between UV coordinates of the current seam vertex and the preceding vertex is smaller than a specified threshold, then a coordinate of a vertex preceding the preceding vertex in a preceding face (e.g., a face incident to the preceding vertex) is used to predict the coordinate of the second vertex in the current face; and (ii) if the current seam vertex has a different UV coordinate as the preceding vertex in the group, the coordinate of the current seam vertex is used to predict the coordinate of the second vertex in the current face.

Coordinates of remaining vertices incident to the current face may be coded as follows: (i) a coordinate of a third vertex in the current face may be coded by a stretch prediction, and (ii) coordinates of remaining vertices in the current face, if any, may be coded by within-parallelogram predictions.

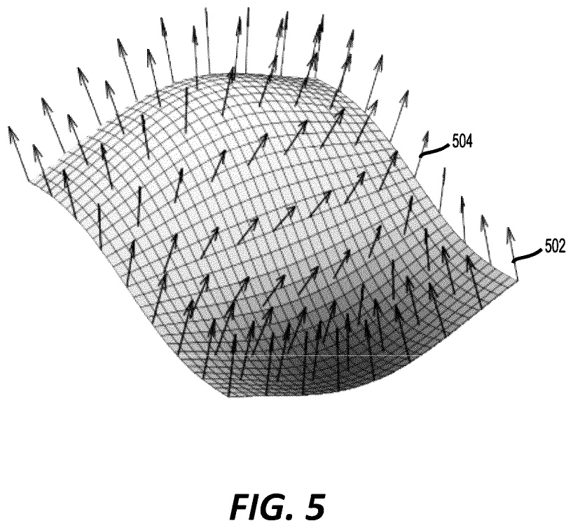

When a polygon mesh contains non-position attributes, such as normals (502) and (504) shown in FIG. 5, connectivity/topology of the normals and values of the normals may be coded by a mesh codec, in which value bitstreams may be larger than connectivity bitstreams. Thus, efficient algorithms to code the normal values are required.

In polygon mesh compression, the normal value bitstream may be a larger portion of a total normal bitstream compared to the normal connectivity bitstream, so efficient methods are needed to code the normal values.

If a polygon mesh contains normals, the normals may be unit vectors or vectors quantized from unit vectors. Without loss of generality, a normal may be a unit vector denoted as follows in equation (1):

$$\begin{matrix}n = {n}_{x} {e}_{x} + {n}_{y} {e}_{y} + {n}_{z} {e}_{z} , & s . t . {n}_{x}^{2} + {n}_{y}^{2} + {n}_{z}^{2} = 1\end{matrix} \qquad Eq . ( l )$$

where eₓ is a unit vector in a x direction, and nₓ is a magnitude of a x component of the normal n in the x direction.

Given a predicted normal vector \hat{n}=\hat{n}ₓeₓ+\hat{n}_{y}e_{y}+n_{z}e_{z}, an arithmetic coding may be applied to code a prediction residual nₓ−nₓ of the x component nₓ and a prediction residual n_{y}−\hat{n}_{y} of the y component n_{y}. After the x and y components nₓ and n_{y} are encoded/decoded, true values of nₓ and n_{y} are obtained, which may be used to predict the z component n_{z}.

In an aspect, instead of directly using the z component n_{z} of the predicted normal vector \hat{n} to predict the z component n_{z} of the normal vector n, based on a fact that a normal vector has two degrees of freedom, n_{z} may be predicted based on nₓ and n_{y}. In an example, n_{z} may be predicted based on nₓ and n_{y} according to equations (2) and (3) as follows:

$${\hat{n}}_{z}^{+} = \sqrt{1 - {n}_{x}^{2} - {n}_{y}^{2}} \qquad Eq . ( 2 )$$

$${\hat{n}}_{\overline{z}} = - \sqrt{1 - {n}_{x}^{2} - {n}_{y}^{2}} \qquad Eq . ( 3 )$$

One of \hat{n}_{z}⁺ and \hat{n}_{z}⁻ may be chosen based on which one of \hat{n}_{z}⁺ and \hat{n}_{z}⁻ is closer to n_{z} as a predictor. In an example, \hat{n}_{z}⁺ is applied to predict n_{z} when n_{z}≥0 (or n_{z}>0) and \hat{n}_{z}⁻ is applied to predict n_{z} when n_{z}≤0 (or n_{z}≤0). In such a way, a prediction error may be smaller than a prediction error by directly using \hat{n}_{z} to predict n_{z}.

In an example of the equations (2) and (3), nₓ is an original value of the x component of the normal vector n in an encoder side and nₓ is a reconstructed value of the x component of the normal vector n in a decoder side.

It should be noted that equations (2) and (3) are merely examples. A same strategy may be applied to predict nₓ if n_{y} and n_{z} are firstly encoded/decoded. Similarly, n_{y} may be predicted based on nₓ and n_{z} if nₓ and n_{z} are firstly encoded/decoded.

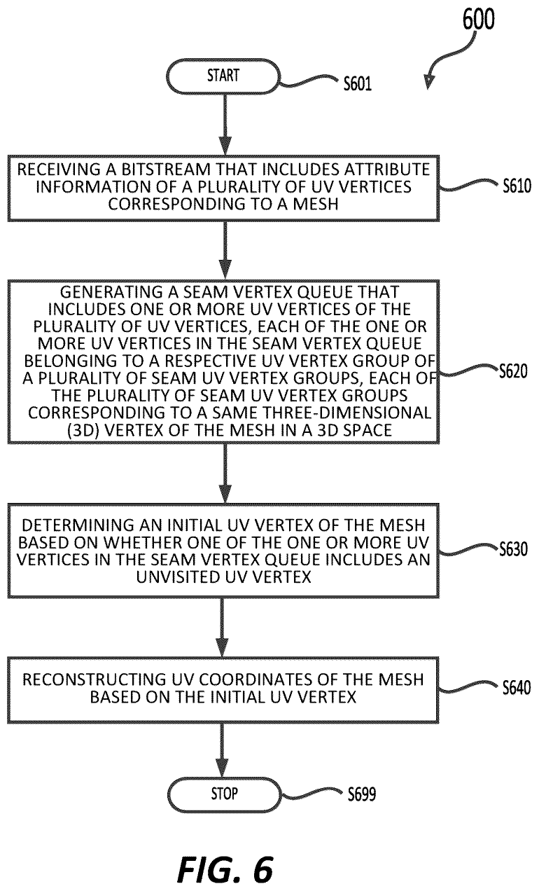

FIG. 6 shows a flow chart outlining a process (600) according to an aspect of the disclosure. The process (600) can be used in a video decoder. In various aspects, the process (600) is executed by processing circuitry, such as the processing circuitry that performs functions of the video decoder (110), the processing circuitry that performs functions of the video decoder (210), and the like. In some aspects, the process (600) is implemented in software instructions, thus when the processing circuitry executes the software instructions, the processing circuitry performs the process (600). The process starts at (S601) and proceeds to (S610).

At (S610), a bitstream that includes attribute information of a plurality of UV vertices corresponding to a mesh is received.

At (S620), a seam vertex queue that includes one or more UV vertices of the plurality of UV vertices is generated. Each of the one or more UV vertices in the seam vertex queue belongs to a respective UV vertex group of a plurality of seam UV vertex groups. Each of the plurality of seam UV vertex groups corresponds to a same three-dimensional (3D) vertex of the mesh in a 3D space.

At (S630), an initial UV vertex of the mesh is determined based on whether one of the one or more UV vertices in the seam vertex queue includes an unvisited UV vertex.

At (S640), UV coordinates of the mesh are reconstructed based on the initial UV vertex.

Then, the process proceeds to (S699) and terminates.

The process (600) can be suitably adapted. Step(s) in the process (600) can be modified and/or omitted. Additional step(s) can be added. Any suitable order of implementation can be used.

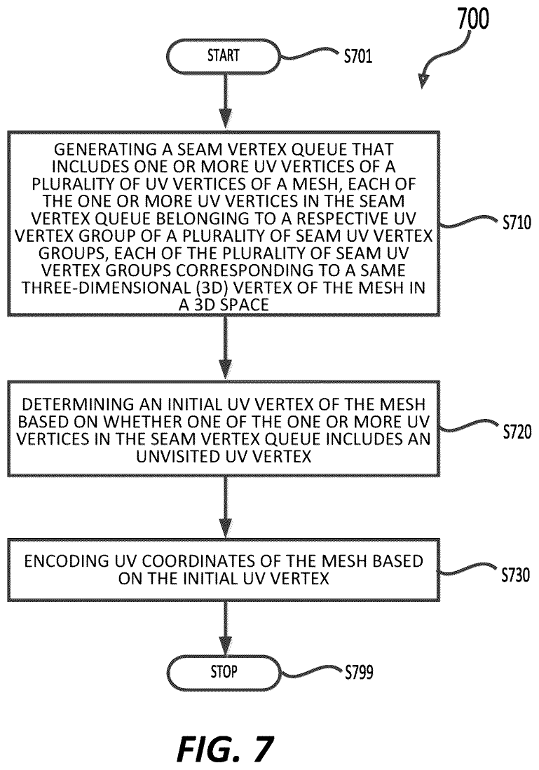

FIG. 7 shows a flow chart outlining a process (700) according to an aspect of the disclosure. The process (700) can be used in a video encoder. In various aspects, the process (700) is executed by processing circuitry, such as the processing circuitry that performs functions of the video encoder (103), the processing circuitry that performs functions of the video encoder (303), and the like. In some aspects, the process (700) is implemented in software instructions, thus when the processing circuitry executes the software instructions, the processing circuitry performs the process (700). The process starts at (S701) and proceeds to (S710).

At (S710), a seam vertex queue that includes one or more UV vertices of a plurality of UV vertices of a mesh is generated. Each of the one or more UV vertices in the seam vertex queue belongs to a respective UV vertex group of a plurality of seam UV vertex groups. Each of the plurality of seam UV vertex groups corresponds to a same three-dimensional (3D) vertex of the mesh in a 3D space.

At (S720), An initial UV vertex of the mesh is determined based on whether one of the one or more UV vertices in the seam vertex queue includes an unvisited UV vertex.

At (S730), UV coordinates of the mesh are encoded based on the initial UV vertex.

Then, the process proceeds to (S799) and terminates.

The process (700) can be suitably adapted. Step(s) in the process (700) can be modified and/or omitted. Additional step(s) can be added. Any suitable order of implementation can be used.

In an aspect, a method of processing mesh data includes processing a bitstream of the mesh data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, a bitstream of the mesh data is processed according to a format rule. The bitstream includes attribute information of a plurality of UV vertices corresponding to a mesh. The format rule specifies that a seam vertex queue that includes one or more UV vertices of the plurality of UV vertices is generated. Each of the one or more UV vertices in the seam vertex queue belongs to a respective UV vertex group of a plurality of seam UV vertex groups. Each of the plurality of seam UV vertex groups corresponds to a same three-dimensional (3D) vertex of the mesh in a 3D space. The format rule specifies that an initial UV vertex of the mesh is determined based on whether one of the one or more UV vertices in the seam vertex queue includes an unvisited UV vertex. The format rule specifies that UV coordinates of the mesh are processed based on the initial UV vertex.

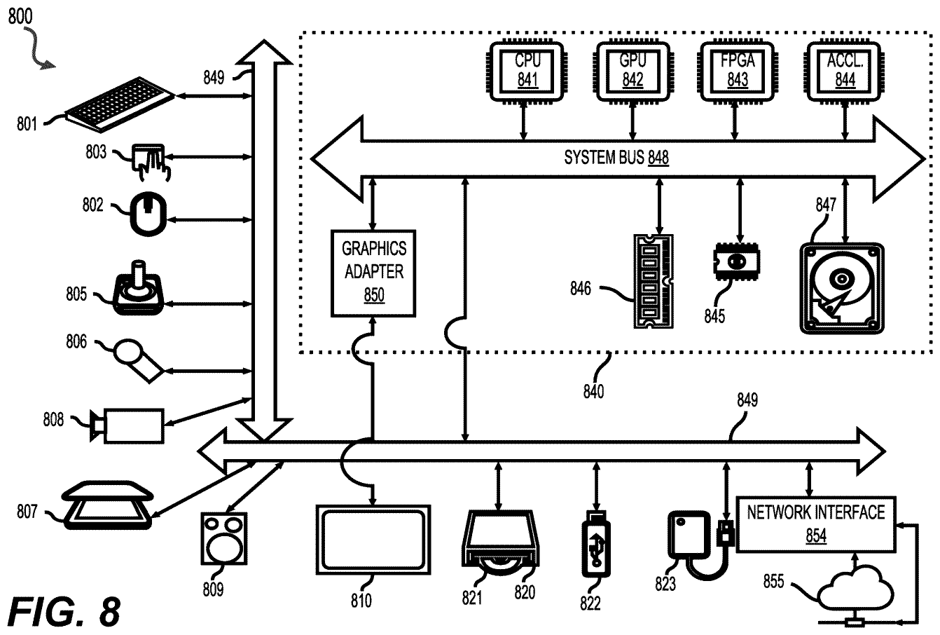

The techniques described above, can be implemented as computer software using computer-readable instructions and physically stored in one or more computer-readable media. For example, FIG. 8 shows a computer system (800) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 8 for computer system (800) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (800).

Computer system (800) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (801), mouse (802), trackpad (803), touch screen (810), data-glove (not shown), joystick (805), microphone (806), scanner (807), camera (808).

Computer system (800) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (810), data-glove (not shown), or joystick (805), but there can also be tactile feedback devices that do not serve as input devices), audio output devices (such as: speakers (809), headphones (not depicted)), visual output devices (such as screens (810) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (800) can also include human accessible storage devices and their associated media such as optical media including CD/DVD ROM/RW (820) with CD/DVD or the like media (821), thumb-drive (822), removable hard drive or solid state drive (823), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (800) can also include an interface (854) to one or more communication networks (855). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (849) (such as, for example USB ports of the computer system (800)); others are commonly integrated into the core of the computer system (800) by attachment to a system bus as described below (for example Ethernet interface into a PC computer system or cellular network interface into a smartphone computer system). Using any of these networks, computer system (800) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (840) of the computer system (800).

The core (840) can include one or more Central Processing Units (CPU) (841), Graphics Processing Units (GPU) (842), specialized programmable processing units in the form of Field Programmable Gate Areas (FPGA) (843), hardware accelerators for certain tasks (844), graphics adapters (850), and so forth. These devices, along with Read-only memory (ROM) (845), Random-access memory (846), internal mass storage such as internal non-user accessible hard drives, SSDs, and the like (847), may be connected through a system bus (848). In some computer systems, the system bus (848) can be accessible in the form of one or more physical plugs to enable extensions by additional CPUs, GPU, and the like. The peripheral devices can be attached either directly to the core's system bus (848), or through a peripheral bus (849). In an example, the screen (810) can be connected to the graphics adapter (850). Architectures for a peripheral bus include PCI, USB, and the like.

CPUs (841), GPUs (842), FPGAs (843), and accelerators (844) can execute certain instructions that, in combination, can make up the aforementioned computer code. That computer code can be stored in ROM (845) or RAM (846). Transitional data can also be stored in RAM (846), whereas permanent data can be stored for example, in the internal mass storage (847). Fast storage and retrieve to any of the memory devices can be enabled through the use of cache memory, that can be closely associated with one or more CPU (841), GPU (842), mass storage (847), ROM (845), RAM (846), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (800), and specifically the core (840) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (840) that are of non-transitory nature, such as core-internal mass storage (847) or ROM (845). The software implementing various aspects of the present disclosure can be stored in such devices and executed by core (840). A computer-readable medium can include one or more memory devices or chips, according to particular needs. The software can cause the core (840) and specifically the processors therein (including CPU, GPU, FPGA, and the like) to execute particular processes or particular parts of particular processes described herein, including defining data structures stored in RAM (846) and modifying such data structures according to the processes defined by the software. In addition or as an alternative, the computer system can provide functionality as a result of logic hardwired or otherwise embodied in a circuit (for example: accelerator (844)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

(1) A method of mesh decoding, the method including: receiving a bitstream that includes attribute information of a plurality of UV vertices corresponding to a mesh; generating a seam vertex queue that includes one or more UV vertices of the plurality of UV vertices, each of the one or more UV vertices in the seam vertex queue belonging to a respective UV vertex group of a plurality of seam UV vertex groups, each of the plurality of seam UV vertex groups corresponding to a same three-dimensional (3D) vertex of the mesh in a 3D space; determining an initial UV vertex of the mesh based on whether one of the one or more UV vertices in the seam vertex queue includes an unvisited UV vertex; and reconstructing UV coordinates of the mesh based on the initial UV vertex.

(2) The method of feature (1), in which the determining the initial UV vertex of the mesh further includes: when a top UV vertex of the seam vertex queue has the unvisited UV vertex in the seam UV vertex group of the top UV vertex, determining a first unvisited UV vertex of the seam UV vertex group of the top UV vertex as the initial UV vertex; and determining a visited UV vertex immediately before the initial UV vertex in the seam UV vertex group of the top UV vertex as a reference UV vertex of the initial UV vertex.

(3) The method of any of features (1) to (2), in which the determining the initial UV vertex of the mesh further includes: when a top UV vertex of the seam vertex queue has no unvisited UV vertices that are in the seam UV vertex group of the top UV vertex, determining whether a UV vertex subsequent to the top UV vertex in the seam vertex queue has one or more unvisited UV vertices that are in the seam UV vertex group of the subsequent UV vertex; and determining a first unvisited UV vertex of the one or more unvisited vertices in the seam UV vertex group of the subsequent vertex as the initial UV vertex when the subsequent UV vertex in the seam vertex queue has the one or more unvisited UV vertices.

(4) The method of any of features (1) to (3), in which the determining the initial UV vertex of the mesh further includes: when the seam vertex queue is empty, determining whether another seam vertex queue of the mesh includes one or more unvisited UV vertices; when the other seam vertex queue of the mesh includes the one or more unvisited UV vertices, determining one of the one or more unvisited UV vertices in the other seam vertex queue as the initial vertex; and determining a visited UV vertex immediately before the initial UV vertex as a reference UV vertex of the initial UV vertex.

(5) The method of any of features (2) to (3), in which the reconstructing further includes: reconstructing UV coordinates of the initial UV vertex based on UV coordinates of the reference UV vertex of the initial UV vertex.

(6) The method of any of features (1) to (5), in which the reconstructing further includes: determining an initial face based on the initial UV vertex, the initial face being incident to the initial UV vertex and including a subset of the plurality of UV vertices of the mesh; and reconstructing UV coordinates of a second UV vertex of the initial face based on UV coordinates of the initial UV vertex.

(7) The method of any of features (2) to (6), in which the reconstructing further includes: determining an initial face based on the initial UV vertex, the initial face being incident to the initial UV vertex and including a subset of the plurality of UV vertices of the mesh; determining a reference face that is incident to the reference UV vertex; and reconstructing UV coordinates of a second UV vertex of the initial face based on UV coordinates of a UV vertex in the reference face that is prior to the reference UV vertex.

(8) The method of any of features (1) to (7), in which the reconstructing further includes: determining an initial face based on the initial UV vertex, the initial face being incident to the initial UV vertex and including a subset of the plurality of UV vertices of the mesh; reconstructing UV coordinates of a third UV vertex of the initial face based on a stretch prediction; and reconstructing UV coordinates of a UV vertex of the initial face that is different from the initial UV vertex, a second UV vertex, and the third UV vertex based on a within-parallelogram prediction.

(9) The method of any of features (1) to (8), further including: determining a current UV vertex in a same seam UV vertex group as the initial UV vertex, the current UV vertex being unvisited; and reconstructing UV vertices of a current face that is incident to the current UV vertex.

(10) The method of feature (9), in which the reconstructing the UV vertices of the current face further includes: reconstructing UV coordinates of the current UV vertex of the current face based on UV coordinates of a preceding visited UV vertex in the same seam UV vertex group; reconstructing UV coordinates of a second UV vertex of the current face based on UV coordinates of a UV vertex prior to a preceding UV vertex of the second UV vertex in a preceding face that is incident to the preceding UV vertex when (i) UV coordinates of the current UV vertex is same as UV coordinates of the preceding visited UV vertex or (ii) a distance between the UV coordinates of the current UV vertex and the UV coordinates of the preceding visited UV vertex is smaller than a predefined threshold; and reconstructing the UV coordinates of the second UV vertex of the current face based on the reconstructed UV coordinates of the current UV vertex when the UV coordinates of the current UV vertex and the UV coordinates of the preceding visited UV vertex are different.

(11) The method of any of features (1) to (10), further including: reconstructing a first component n₁ of a first normal n of the mesh and a second component n₂ of the first normal n based on the attribute information of the mesh in the bitstream; reconstructing a third component n₃ of the first normal n as a square root of (1−n₁²−n₂²) when the third component n₃ is equal to or larger than zero; and reconstructing the third component n₃ of the first normal n as a negative square root of (1-n₁−n₂) when the third component n₃ is less than zero.

(12) A method of mesh encoding, the method including: generating a seam vertex queue that includes one or more UV vertices of a plurality of UV vertices of a mesh, each of the one or more UV vertices in the seam vertex queue belonging to a respective UV vertex group of a plurality of seam UV vertex groups, each of the plurality of seam UV vertex groups corresponding to a same three-dimensional (3D) vertex of the mesh in a 3D space; determining an initial UV vertex of the mesh based on whether one of the one or more UV vertices in the seam vertex queue includes an unvisited UV vertex; and encoding UV coordinates of the mesh based on the initial UV vertex.

(13) The method of feature (12), in which the determining the initial UV vertex of the mesh further includes: when a top UV vertex of the seam vertex queue has the unvisited UV vertex in the seam UV vertex group of the top UV vertex, determining a first unvisited UV vertex of the seam UV vertex group of the top UV vertex as the initial UV vertex; and determining a visited UV vertex immediately before the initial UV vertex in the seam UV vertex group of the top UV vertex as a reference UV vertex of the initial UV vertex.

(14) The method of any of features (12) to (13), in which the determining the initial UV vertex of the mesh further includes: when a top UV vertex of the seam vertex queue has no unvisited UV vertices that are in the seam UV vertex group of the top UV vertex, determining whether a UV vertex subsequent to the top UV vertex in the seam vertex queue has one or more unvisited UV vertices that are in the seam UV vertex group of the subsequent UV vertex; and determining a first unvisited UV vertex of the one or more unvisited vertices in the seam UV vertex group of the subsequent vertex as the initial UV vertex when the subsequent UV vertex in the seam vertex queue has the one or more unvisited UV vertices.

(15) The method of any of features (12) to (14), in which the determining the initial UV vertex of the mesh further includes: when the seam vertex queue is empty, determining whether another seam vertex queue of the mesh includes one or more unvisited UV vertices; when the other seam vertex queue of the mesh includes the one or more unvisited UV vertices, determining one of the one or more unvisited UV vertices in the other seam vertex queue as the initial vertex; and determining a visited UV vertex immediately before the initial UV vertex as a reference UV vertex of the initial UV vertex.

(16) The method of any of features (13) to (15), in which the encoding further includes: encoding UV coordinates of the initial UV vertex based on UV coordinates of the reference UV vertex of the initial UV vertex.

(17) The method of any of features (12) to (16), in which the encoding further includes: determining an initial face based on the initial UV vertex, the initial face being incident to the initial UV vertex and including a subset of the plurality of UV vertices of the mesh; and encoding UV coordinates of a second UV vertex of the initial face based on UV coordinates of the initial UV vertex.

(18) The method of any of features (13) to (17), in which the encoding further include: determining an initial face based on the initial UV vertex, the initial face being incident to the initial UV vertex and including a subset of the plurality of UV vertices of the mesh; determining a reference face that is incident to the reference UV vertex; and encoding UV coordinates of a second UV vertex of the initial face based on UV coordinates of a UV vertex in the reference face that is prior to the reference UV vertex.

(19) The method of any of features (12) to (18), in which the encoding further includes: determining an initial face based on the initial UV vertex, the initial face being incident to the initial UV vertex and including a subset of the plurality of UV vertices of the mesh; encoding UV coordinates of a third UV vertex of the initial face based on a stretch prediction; and encoding UV coordinates of a UV vertex of the initial face that is different from the initial UV vertex, a second UV vertex, and the third UV vertex based on a within-parallelogram prediction.

(20) A method of processing mesh data, the method including: processing a bitstream of the mesh data according to a format rule, wherein: the bitstream includes attribute information of a plurality of UV vertices corresponding to a mesh; and the format rule specifies that: a seam vertex queue that includes one or more UV vertices of the plurality of UV vertices is generated, each of the one or more UV vertices in the seam vertex queue belonging to a respective UV vertex group of a plurality of seam UV vertex groups, each of the plurality of seam UV vertex groups corresponding to a same three-dimensional (3D) vertex of the mesh in a 3D space; an initial UV vertex of the mesh is determined based on whether one of the one or more UV vertices in the seam vertex queue includes an unvisited UV vertex; and UV coordinates of the mesh are processed based on the initial UV vertex.

(21) A method of mesh decoding, the method including: reconstructing a first component n₁ of a first normal n of a mesh and a second component n₂ of the first normal n based on attribute information of the mesh in a bitstream; reconstructing a third component n₃ of the first normal n as a square root of (1−n₁²−n₂²) when the third component n₃ is equal to or larger than zero; and reconstructing the third component n₃ of the first normal n as a negative square root of (1−n₁²−n₂²) when the third component n₃ is less than zero.

(22) A method of mesh encoding, the method including: determining an initial face based on an initial UV vertex, the initial face being incident to the initial UV vertex and including a subset of a plurality of UV vertices of a mesh; encoding UV coordinates of a third UV vertex of the initial face based on a stretch prediction; and encoding UV coordinates of a UV vertex of the initial face that is different from the initial UV vertex, a second UV vertex, and the third UV vertex based on a within-parallelogram prediction.

(23) A method of processing mesh data, the method including: processing a bitstream of the mesh data according to a format rule, wherein: the bitstream includes attribute information of a mesh; and the format rule specifies that: a first component n₁ of a first normal n of a mesh and a second component n₂ of the first normal n are reconstructed based on attribute information of the mesh in a bitstream; a third component n₃ of the first normal n is reconstructed as a square root of (1−n₁²−n₂²) when the third component n₃ is equal to or larger than zero; and the third component n₃ of the first normal n is reconstructed as a negative square root of (1-n₁−n²) when the third component n₃ is less than zero.

(24) An apparatus for mesh decoding, including processing circuitry that is configured to perform the method of any of features (1) to (11) and (21).

(25) An apparatus for mesh encoding, including processing circuitry that is configured to perform the method of any of features (12) to (19) and (22).

(26) A non-transitory computer-readable storage medium storing instructions which when executed by at least one processor cause the at least one processor to perform the method of any of features (1) to (23).

What is claimed is:

1. A method of mesh decoding, comprising:
receiving a bitstream that includes attribute information of a plurality of UV vertices corresponding to a mesh;
generating a seam vertex queue that includes one or more UV vertices of the plurality of UV vertices, each of the one or more UV vertices in the seam vertex queue belonging to a respective UV vertex group of a plurality of seam UV vertex groups, each of the plurality of seam UV vertex groups corresponding to a same three-dimensional (3D) vertex of the mesh in a 3D space;
determining an initial UV vertex of the mesh based on whether one of the one or more UV vertices in the seam vertex queue includes an unvisited UV vertex; and
reconstructing UV coordinates of the mesh based on the initial UV vertex.

2. The method of claim 1, wherein the determining the initial UV vertex of the mesh further comprises:
when a top UV vertex of the seam vertex queue has the unvisited UV vertex in the seam UV vertex group of the top UV vertex, determining a first unvisited UV vertex of the seam UV vertex group of the top UV vertex as the initial UV vertex; and
determining a visited UV vertex immediately before the initial UV vertex in the seam UV vertex group of the top UV vertex as a reference UV vertex of the initial UV vertex.

3. The method of claim 1, wherein the determining the initial UV vertex of the mesh further comprises:
when a top UV vertex of the seam vertex queue has no unvisited UV vertices that are in the seam UV vertex group of the top UV vertex, determining whether a UV vertex subsequent to the top UV vertex in the seam vertex queue has one or more unvisited UV vertices that are in the seam UV vertex group of the subsequent UV vertex; and
determining a first unvisited UV vertex of the one or more unvisited vertices in the seam UV vertex group of the subsequent vertex as the initial UV vertex when the subsequent UV vertex in the seam vertex queue has the one or more unvisited UV vertices.

4. The method of claim 1, wherein the determining the initial UV vertex of the mesh further comprises:
when the seam vertex queue is empty, determining whether another seam vertex queue of the mesh includes one or more unvisited UV vertices;
when the other seam vertex queue of the mesh includes the one or more unvisited UV vertices, determining one of the one or more unvisited UV vertices in the other seam vertex queue as the initial vertex; and
determining a visited UV vertex immediately before the initial UV vertex as a reference UV vertex of the initial UV vertex.

5. The method of claim 2, wherein the reconstructing further comprises:
reconstructing UV coordinates of the initial UV vertex based on UV coordinates of the reference UV vertex of the initial UV vertex.

6. The method of claim 1, wherein the reconstructing further comprises:
determining an initial face based on the initial UV vertex, the initial face being incident to the initial UV vertex and including a subset of the plurality of UV vertices of the mesh; and
reconstructing UV coordinates of a second UV vertex of the initial face based on UV coordinates of the initial UV vertex.

7. The method of claim 2, wherein the reconstructing further comprises:
determining an initial face based on the initial UV vertex, the initial face being incident to the initial UV vertex and including a subset of the plurality of UV vertices of the mesh;
determining a reference face that is incident to the reference UV vertex; and
reconstructing UV coordinates of a second UV vertex of the initial face based on UV coordinates of a UV vertex in the reference face that is prior to the reference UV vertex.

8. The method of claim 1, wherein the reconstructing further comprises:
determining an initial face based on the initial UV vertex, the initial face being incident to the initial UV vertex and including a subset of the plurality of UV vertices of the mesh;
reconstructing UV coordinates of a third UV vertex of the initial face based on a stretch prediction; and
reconstructing UV coordinates of a UV vertex of the initial face that is different from the initial UV vertex, a second UV vertex, and the third UV vertex based on a within-parallelogram prediction.

9. The method of claim 1, further comprising:
determining a current UV vertex in a same seam UV vertex group as the initial UV vertex, the current UV vertex being unvisited; and
reconstructing UV vertices of a current face that is incident to the current UV vertex.

10. The method of claim 9, wherein the reconstructing the UV vertices of the current face further comprises:
reconstructing UV coordinates of the current UV vertex of the current face based on UV coordinates of a preceding visited UV vertex in the same seam UV vertex group;
reconstructing UV coordinates of a second UV vertex of the current face based on UV coordinates of a UV vertex prior to a preceding UV vertex of the second UV vertex in a preceding face that is incident to the preceding UV vertex when (i) UV coordinates of the current UV vertex is same as UV coordinates of the preceding visited UV vertex or (ii) a distance between the UV coordinates of the current UV vertex and the UV coordinates of the preceding visited UV vertex is smaller than a predefined threshold; and
reconstructing the UV coordinates of the second UV vertex of the current face based on the reconstructed UV coordinates of the current UV vertex when the UV coordinates of the current UV vertex and the UV coordinates of the preceding visited UV vertex are different.

11. The method of claim 1, further comprising:
reconstructing a first component n₁ of a first normal n of the mesh and a second component n₂ of the first normal n based on the attribute information of the mesh in the bitstream;
reconstructing a third component n₃ of the first normal n as a square root of (1−n₁²−n₂²) when the third component n₃ is equal to or larger than zero; and
reconstructing the third component n₃ of the first normal n as a negative square root of (1−n₁²−n₂²) when the third component n₃ is less than zero.

12. A method of mesh encoding, comprising:
generating a seam vertex queue that includes one or more UV vertices of a plurality of UV vertices of a mesh, each of the one or more UV vertices in the seam vertex queue belonging to a respective UV vertex group of a plurality of seam UV vertex groups, each of the plurality of seam UV vertex groups corresponding to a same three-dimensional (3D) vertex of the mesh in a 3D space;
determining an initial UV vertex of the mesh based on whether one of the one or more UV vertices in the seam vertex queue includes an unvisited UV vertex; and
encoding UV coordinates of the mesh based on the initial UV vertex.

13. The method of claim 12, wherein the determining the initial UV vertex of the mesh further comprises:
when a top UV vertex of the seam vertex queue has the unvisited UV vertex in the seam UV vertex group of the top UV vertex, determining a first unvisited UV vertex of the seam UV vertex group of the top UV vertex as the initial UV vertex; and
determining a visited UV vertex immediately before the initial UV vertex in the seam UV vertex group of the top UV vertex as a reference UV vertex of the initial UV vertex.

14. The method of claim 12, wherein the determining the initial UV vertex of the mesh further comprises:
when a top UV vertex of the seam vertex queue has no unvisited UV vertices that are in the seam UV vertex group of the top UV vertex, determining whether a UV vertex subsequent to the top UV vertex in the seam vertex queue has one or more unvisited UV vertices that are in the seam UV vertex group of the subsequent UV vertex; and
determining a first unvisited UV vertex of the one or more unvisited vertices in the seam UV vertex group of the subsequent vertex as the initial UV vertex when the subsequent UV vertex in the seam vertex queue has the one or more unvisited UV vertices.

15. The method of claim 12, wherein the determining the initial UV vertex of the mesh further comprises:
when the seam vertex queue is empty, determining whether another seam vertex queue of the mesh includes one or more unvisited UV vertices;
when the other seam vertex queue of the mesh includes the one or more unvisited UV vertices, determining one of the one or more unvisited UV vertices in the other seam vertex queue as the initial vertex; and
determining a visited UV vertex immediately before the initial UV vertex as a reference UV vertex of the initial UV vertex.

16. The method of claim 13, wherein the encoding further comprises:
encoding UV coordinates of the initial UV vertex based on UV coordinates of the reference UV vertex of the initial UV vertex.

17. The method of claim 12, wherein the encoding further comprises:
determining an initial face based on the initial UV vertex, the initial face being incident to the initial UV vertex and including a subset of the plurality of UV vertices of the mesh; and
encoding UV coordinates of a second UV vertex of the initial face based on UV coordinates of the initial UV vertex.

18. The method of claim 13, wherein the encoding further comprises:
determining an initial face based on the initial UV vertex, the initial face being incident to the initial UV vertex and including a subset of the plurality of UV vertices of the mesh;
determining a reference face that is incident to the reference UV vertex; and
encoding UV coordinates of a second UV vertex of the initial face based on UV coordinates of a UV vertex in the reference face that is prior to the reference UV vertex.

19. The method of claim 12, wherein the encoding further comprises:
determining an initial face based on the initial UV vertex, the initial face being incident to the initial UV vertex and including a subset of the plurality of UV vertices of the mesh;
encoding UV coordinates of a third UV vertex of the initial face based on a stretch prediction; and
encoding UV coordinates of a UV vertex of the initial face that is different from the initial UV vertex, a second UV vertex, and the third UV vertex based on a within-parallelogram prediction.

20. A method of processing mesh data, the method comprising:
processing a bitstream of the mesh data according to a format rule, wherein:
the bitstream includes attribute information of a plurality of UV vertices corresponding to a mesh; and
the format rule specifies that:
a seam vertex queue that includes one or more UV vertices of the plurality of UV vertices is generated, each of the one or more UV vertices in the seam vertex queue belonging to a respective UV vertex group of a plurality of seam UV vertex groups, each of the plurality of seam UV vertex groups corresponding to a same three-dimensional (3D) vertex of the mesh in a 3D space;
an initial UV vertex of the mesh is determined based on whether one of the one or more UV vertices in the seam vertex queue includes an unvisited UV vertex; and
UV coordinates of the mesh are processed based on the initial UV vertex.
